(19) United States
(12) Patent Application Publication
(10) Pub. No.: US 2025/0183340 A1
(43) Pub. Date: Jun. 5, 2025

(54) MEMBRANE ELECTRODE ASSEMBLIES USING ANION EXCHANGE MEMBRANES AND ANION EXCHANGE POLYMERS

(71) Applicant: USA Fortescue IP, INC, Wilmington, DE (US)

(72) Inventors: Mengjie Chen, Seaford, DE (US); Bamdad Bahar, Georgetown, DE (US)

(21) Appl. No.: 19/036,465

(22) Filed: Jan. 24, 2025

Related U.S. Application Data
(63) Continuation-in-part of application No. PCT/US23/28743, filed on Jul. 26, 2023.
(60) Provisional application No. 63/392,476, filed on Jul. 26, 2022.
(60) Provisional application No. 63/624,878, filed on Jan. 25, 2024.

(51) Int. Cl. H01M 8/1004; H01M 4/92; H01M 8/10; H01M 8/1023

(52) U.S. Cl. CPC H01M 8/1004; H01M 4/926; H01M 8/1023; H01M 2008/1095

(57) ABSTRACT

A membrane electrode assembly includes an anion conducting membrane and electrodes. The membrane electrode assembly is made from two different polymers in one system. The membrane electrode assembly of this invention is suitable for use in electrochemical devices, including anion exchange membrane electrolyzers.

### CROSS REFERENCE TO RELATED APPLICATIONS

This application is a continuation in part of international patent application No. PCT/US2023/028743, filed on Jul. 26, 2023, which claims the benefit of priority to U.S. provisional which claims the benefit of priority to U.S. provisional patent application No. 63/392,476 filed on Jul. 26, 2022, and this application claims the benefit of priority to U.S. provisional patent application No. 63/624,878, filed on Jan. 25, 2024; the entirety of each priority application is hereby incorporated by reference herein.

### FIELD OF THE INVENTION

This invention relates to membrane electrode assemblies suitable for use in electrochemical devices, including anion exchange membrane electrolyzers, and methods for making same. It provides two families of polymers/ionomers capable of forming composite membranes having good OH⁻ ionic conductivity and mechanical strength. The invention also provides electrodes including a different family of polymers/ionomers with excellent ionic conductivity.

### BACKGROUND OF THE INVENTION

Electrochemical devices, including anion exchange membrane (AEM) fuel cells, sensors, electrolyzers, have been constructed from membrane electrode assemblies (MEAs). Such membrane electrode assemblies comprise two electrodes which are in contact with an ion conductive membrane. Anion conductive membranes are used in electrochemical cells as solid electrolytes. In a typical electrochemical cell, an AEM is in contact with a cathode and an anode, and transports ions that are formed at the cathode to the anode, allowing current to flow in an external circuit connecting the electrodes. The central component of an electrochemical cell, such as a fuel cell, sensor, electrolyzer, is the three-layer membrane electrode assembly. It consists, in the most general sense, of two electrodes between which is sandwiched an anion exchange membrane. This 3-layer membrane electrode assembly is in turn sandwiched between two porous, electrically conducting elements called gas diffusion layers (GDLs) or porous transport layers (PTLs), to form a 5-layer membrane electrode assembly.

Anion exchange membranes (AEMs) are solid polymer electrolyte membranes which allow for the transportation of anions (e.g. OH⁻, C⁻, Br⁻) under a chemical or electrical potential. Anion exchange membranes consist of polymers containing fixed positively charged functional groups and mobile negatively charged ions.

Anion exchange membranes are a critical component of anion exchange membrane fuel cells (AEMFCs), where hydrogen and oxygen are consumed to generate electricity with water as a byproduct. Anion exchange membranes are also used in anion exchange membrane electrolyzers (AEMELs), where water is split into hydrogen and oxygen using electricity. In both anion exchange membrane fuel cells and water electrolysis, hydroxide ions and water are transported across the membrane. AEMFCs and AEMELs have garnered recent interest due to their potential to eliminate the need for expensive platinum group metal catalysts, fluorinated ionomers, and acid-resistant metals in these electrochemical systems. Anion exchange membranes may also be used in batteries, sensors, electrochemical compressors, and various separation applications.

AEMs require a higher activation energy for hydroxide ion transport compared to proton transport in proton exchange membranes. To achieve high ionic conductivity and hydrophilic-domain phase separation, AEMs are designed to have high ion exchange capacity. High ion exchange capacity increases water uptake and hydrophilic-domain phase separation, leading to a reduction in mechanical strength and dimensional stability.

The ionomer used in both anode and cathode provides an ionic pathway in the electrode between the solid polymer membrane and the catalyst particles on the PTLs/GDLs. The ionomer also plays a crucial role in providing adhesion among the components in the membrane electrode assembly.

There is therefore a need for inexpensive, high ion-conducting, chemically stable membrane electrode assembly materials to enable the performance of developing electrochemical systems.

### SUMMARY OF THE INVENTION

The present invention provides membrane electrode assembly comprising anion exchange membrane with a membrane anion exchange polymer and electrodes layers comprising an electrode anion exchange polymer, wherein the membrane and electrode anion exchange polymers may be different in the membrane electrode assembly system.

An exemplary anion exchange polymer is polymer that is functionalized with quaternary ammonium groups. Polynorbornene, poly(phenylene) or polyxanthene polymer may be imbibed into or otherwise coupled with one or more porous support layers for reinforcement and used as an anion conducting membrane between an anode and a cathode in an anion exchange membrane. The reinforcement can be single porous support layer or multiple support layers with anion exchange polymer coupled to each layer, such as being imbibed into the layer or layers. In the case of multiple layers, the anion exchange polymer may be configured between the support layers and bond the support layers together. The polynorbornene, poly(phenylene) or polyxanthene anion exchange polymer may also be used in the anode or cathode of an AEM as well or may form an interface layer with the anode and cathode and may act as an adhesive to bond the anode and/or cathode to the anion exchange membranes.

An exemplary anion exchange polymer is polyimidazolium polymer or poly(arylimidazolium) polymer that may be imbibed into or otherwise coupled with single support layer or multiple support layers of support material, such as a porous or microporous support material for reinforcement. The polyimidazolium or poly(arylimidazolium) anion exchange polymer is preferable used in the anode or cathode as a binder and ion conducting media of a membrane electrode assembly. Polyimidazolium or poly(arylimidazolium) anion exchange polymer may be used for electrodes preparation in the catalyst layer, which is functionalized before preparation. The polyimidazolium or poly(arylimidazolium) anion exchange polymer anion exchange polymer may be coupled with catalyst to form the anode and cathode and may bond with the polynorbornene, poly(phenylene) or polyxanthene of the anion exchange membrane. The anion exchange membrane may comprise polyimidazolium or poly(arylimidazolium) as well and preferably in a small percentage. In an exemplary embodiment, the anion exchange polymer of the anion exchange membrane is different from the anion exchange polymer in the anode and/or cathode. In a preferred embodiment, the anion exchange polymer of the anion exchange membrane is polynorbornene either block or random polynorbornene and the anion exchange polymer in the anode and/or cathode is poly(arylimidazolium). The poly(arylimidazolium) provides better mechanical binding of the anode and/or cathode catalyst and catalyst support materials while the polynorbonene may provide improved conductivity and durability in the anion exchange membrane.

In a preferred embodiment, the anode and cathode have an anion exchange polymer that consists of, or consists essentially of polyimidazolium or consists of poly(arylimidazolium), wherein at least 90% of the anion exchange polymer in the anode or cathode, and preferably at least 95% is polyimidazolium. As described herein, the anode and cathode may comprise polynorbornene, poly(phenylene) or poly(arylimidazolium). Likewise, the anion exchange membrane may utilize an anion exchange polymer that is polynorbornene, poly(phenylene) or polyxanthene that consists essentially of polynorbornene, poly(phenylene) or polyxanthene, wherein at least 90% of the anion exchange polymer in the anode or cathode, and preferably at least 95% is polynorbornene, poly(phenylene) or polyxanthene, respectively. This configuration provides for better ion conductivity and stability. The polyimidazolium or poly(arylimidazolium) provides better performance in the anode and the cathode with respect to water management, wherein it may have less water gain and therefore swell less with water and perform better in saturated conditions. The polyimidazolium or poly(arylimidazolium) may prevent the anode and/or cathode from flooding than polynorbornene, poly(phenylene) or polyxanthene. The polynorbornene, poly(phenylene) or polyxanthene anion exchange polymer is preferred in the anion exchange polymer and anion exchange membrane as it is more durable.

An anion exchange membrane is prepared by imbibing a polymer solution of a non-ionic precursor polymer with one or more porous support layer materials followed by conversion of a functional moiety on the polymer to form a trimethyl ammonium cation. Such a conversion can be accomplished by treatment of the precursor polymer membrane with trimethylamine. In addition, an optional chemical crosslinking reaction can also be used to toughen the polymer by converting it from a thermoplastic to a thermoset material. Such a conversion can be accomplished by treatment of the precursor polymer membrane by a diamine, which is typically performed before the amination reaction. Amination is functionalizing of the anion exchange polymer. Typically, the thickness of the functionalized membrane is 75 micrometers or less, more typically 50 micrometers or less, and in some embodiments, 20 micrometers or less.

The anion exchange polymer may be cross-linked to improve mechanical properties and increase durability of the anion exchange polymer. The cross-linking concentration of a blocked or random polymer, such as blocked polynorbornene or random polynorbornene may be on the order of about 5 mol % or more, about 10 mol % or more, about 15 mol % or more, about 20 mol % or more, about 25 mol % or more, about 35 mol % or more, to as much as 50 mol % or less, and any range between and including the cross-linking concentrations provided. A particular range of cross-linking concentration that may be preferred is 10 mol % to about 30 mol %, as this range may provide the optimum combination of durability and conductivity of the anion exchange polymer. A higher degree of cross-linking may provide improved mechanical and durability properties and may prevent excessing swelling of the polymer from water. Also, a higher degree of cross-linking will improve chemical resistance as there are less reactive sites for attach by chemical compounds, therefore chemical stability is improved with a higher concentration of cross-linking. It should be noted that a longer cross-linking compound may provide improved durability but enable elasticity and flexibility of the polymer, which may enable higher conductivity. Therefore, a higher concentration of cross-linking combined with a longer cross-linking compound, (higher carbon atom cross-linker), is preferred for the combined properties of durability and elasticity along with high conductivity. Also, another preferred cross-linking concentration is less than 2 mol %, such as about 1.75 mol % or less, about 1.5 mol %, about 1.25 mol %, about 1 mol % or less and any range between and including the cross-linking concentrations provided.

The cross-linking compound may be selected from the group consisting of: N,N,N′,N′-tetramethyl-1,2-ethanediamine (TMEDA); N,N,N′,N′-tetraethyl-1,2-ethanediamine (TEEDA); N,N,N′,N′-tetramethyl-1,3-propanediamine (TMPDA); N,N,N′,N′-tetraethyl-1,3-propanediamine (TEPDA); N,N,N′,N′-tetramethyl-1,4-butanediamine (TMBDA); N,N,N′,N′-tetramethyl-1,5-pentanediamine (TMPeDA); N,N,N′,N′-tetramethyl-1,6-hexanediamine (TMHDA); N,N,N′,N′-tetraethyl-1,6-hexanediamine (TEHDA); N,N-dimehtyl-N′,N′-diethyl-1,6-hexanediamine (DMDEHDA); N,N,N′,N′-tetramethyl-1,8-octanediamine (TMODA); N,N,N′,N′-tetramethyl-1,10-dodecanediamine (TMDDA); 1,4-bis(N,N′-dimethyl)cyclohexane; and 1,4-bis(N,N′-dimethyl)benzene. N¹,N¹,N²,N²,N³,N³-liexarnetliylpropane-1,2,3-triamine; N¹,N¹,N³,N³, N⁶,N⁶-liexametliy lhexane-1,3,6-triamine; N¹,N¹,N⁴,N⁴,N⁸,N⁸-liexamethyloctane-1,4,8-triamine; N¹,N¹,N⁴,N⁴,N⁶,N⁶,N⁸,N⁸-octamethyloctane-1,4,6,8-tetraamine; N¹,N¹,N³,N³,N⁵,N⁵-hexamethylcyclohexane-1,3,5-triamine; and N¹,N¹,N³,N³,N⁵,N⁵-hexamethy Ibenzene-1,3,5-triamine.

A cross-linking compound that is long, defined by the number of carbons along the chain, is preferred as it enables effective swelling of the anion exchange polymer while increasing durability. A cross-linking compound may have about 11 carbon atoms or more, about 15 of carbon atoms or more, about 20 carbon atoms or more and any range between and including the values provided.

The electrodes may be prepared by coating the mixture of catalyst and functionalized polyimidazolium or poly(arylimidazolium) polymer onto a gas diffusion layer or may be coated directly onto the anion exchange membrane, such as by spray coating, printing, or by decal transfer.

It is critical to have different polymers in one membrane electrode assembly structure. The polymer used in the membrane can be different from the polymer used in the electrodes to improve the performance of the electrochemical cell such as electrolyzer or electrochemical cell. At anode, the hydroxides are consumed to produce oxygen. In the case of the anode, water uptake was the critical factor in performance because excess swelling in the water-fed electrode negated the benefits of high ionic conductivity. It is noted that the volume fraction of hydrated ionomer in the electrode is significantly greater in the case of electrodes with high ion exchange capacity (IEC) ionomer compared to low IEC ionomers. Excess water uptake can swell the ionomer and disrupt the three-phase boundary needed in the electrode, leading to higher resistance and lower performance. It is also possible that high ionomer swelling can decrease the void volume between the catalyst particles. An electrically insulating film of residual ionomer can form around the catalyst particles leading to a higher contact resistance and kinetic overpotential. Water is consumed at cathode to produce hydrogen. The HER electrode, on the other hand, requires a higher local water activity because water is consumed at the HER electrode to form hydrogen and hydroxide ions, and is supplied only by diffusion from the water reservoir at the anode. Therefore, it is important to choose optimized polymer in the electrodes and the ionomers used in electrode can be different from that used in membranes. Also, the conductivity of polymer used in the membrane is more important than that of polymer used in the electrodes. Because the anode is usually fed with supporting electrolyte, which facilitates the conductivity of electrode.

Polyimidazolium or poly(arylimidazolium) offers a balanced alkaline stability and high IEC that provides exceptional chemical stability and hydroxide conductivity with low water content by tuning steric-protecting groups at the C2 position and different alkyl side chains attached to the N1/N3 imidazole position.

Exemplary polynorbornene, poly(phenylene), polyxanthene, poly(arylimidazolium) and polyimidazolium may have functional groups selected from the group of quaternary ammoniums, tertiary diamines, phosphonium, benz(imidazolium), sulphonium, guanidinium, imidazolium, metal cations, pyridinium, trimethylammonium(TMA), 1-methylpyrrolidinium(MPY), 1-methylpiperidinium (MPRD), 1-methylimidazolium (Im1) and 1,2-dimethylimidazolium (Im1,2). Preferably the functional group is quaternary ammonium. The mol percent of the functional groups in terms of monomer can be varying from 18% to 80%, or about 25% to about 80%, or about 50% to 80%, or even about 60% to 80%. A higher mol percent of the functional groups with respect to the monomer or anion conducting polymer may provide higher anion conductivity.

An anion exchange polymer may include a backbone selected from the group consisting of: polynornborenes, polyphenylenes, polyimidazoles, perfluorinated, partially fluorinated, hydrocarbon, polyfluorene, and ployxanthene; a side chain selected from the group consisting of: N-heterocyclic, alkyl, aryl, alkane, ether and alkene; and a functional group selected from the group consisting of: quaternary ammonium, or imidazolium, and pyridinium.

An exemplary porous support layer is made from polymer group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers, polyether ether ketones (PEEK).

Exemplary polynorbornene, polyphenylene, polyxanthene, poly(arylimidazolium) and polyimidazolium may have additive selected from a group consisting of radical scavengers, plasticizers, fillers, anion conducting material, crosslinking agent.

Exemplary porous transport layer and gas diffusion layer is made from nickel foam, nickel fiber felt, nickel woven, sintered Ni plate, titanium felt, carbon paper, carbon cloth. Owing to the corrosion which can be caused at the anode side, materials based on carbon cannot be used on the anode side of an electrolysis membrane electrode assembly.

An exemplary membrane electrode assembly comprises an anion exchange membrane comprising a membrane anion exchange polymer that comprises polynorbornene, polyxanthene or poly(phenylene) having membrane functional groups; an anode comprising an anode catalyst; and a cathode comprising a cathode catalyst, wherein at least one of the anode or cathode comprises an electrode anion exchange polymer comprising polyimidazolium polymer or poly(arylimidazolium) comprising an electrode functional group.

The membrane functional group may comprise quaternary ammonium, tertiary diamines, phosphonium, benz(imidazolium), sulphonium, guanidinium, metal cations, and/or pyridinium. Quaternary ammonium may be a preferred functional group. The membrane functional group may comprise pyridinium. The membrane anion exchange polymer may include polynorbornene and the membrane functional group may comprise quaternary ammonium, in an exemplary embodiment. The membrane anion exchange polymer may include polyxanthene and the membrane functional group may include quaternary ammonium, tertiary diamines, phosphonium, benz(imidazolium), sulphonium, guanidinium, metal cations, and/or pyridinium. The membrane anion exchange polymer may include polyxanthene and the membrane functional group may include quaternary ammonium.

The membrane anion exchange polymer may include polynorbornene and a functional group comprising quaternary ammonium, tertiary diamines, phosphonium, benz(imidazolium), sulphonium, guanidinium, metal cations and/or pyridinium. The membrane anion exchange polymer may include polynorbornene and the membrane functional group may comprise quaternary ammonium, in an exemplary embodiment. The membrane anion exchange polymer may include poly(phenylene) or polyxanthene and the membrane functional group may include quaternary ammonium, tertiary diamines, phosphonium, benz(imidazolium), sulphonium, guanidinium, metal cations, and/or pyridinium. The membrane anion exchange polymer may include poly(phenylene) or polyxanthene and the membrane functional group may include quaternary ammonium.

The membrane anion exchange polymer may include an additive selected from a group consisting of radical scavengers, plasticizers, fillers, anion conducting material, crosslinking agent. An exemplary radical scavenger is an antioxidant selected from the group consisting of Cerium (Ce), Manganese (Mn), phenolic compounds, nitrogen-containing heterocyclic compounds, quinones, amine, phosphites, phosphonites, and thioesters. An exemplary plasticizer is selected from the group consisting of nylon 6,6, Glycerol and ionic liquids. An exemplary filler is a hygroscopic inorganic filler. An exemplary filler is a carbon-based material selected from the group consisting of oxides of aluminum, silicon, titanium, zirconium and zirconium phosphate, cesium phosphate, zeolites, clays and carbon black, multiwall carbon nanotubes, reduced graphene oxide. An exemplary crosslinking agent comprise tertiary diamine head groups which include DABCO (1,4-diazabicyclo[2,2,2]octane) and TMHDA (N,N,N,N-tetramethylhexane diammonium), 1,4-diiodobutane. TMHDA is preferred because the solubility is better and it has been found to give better performance. See Example 3, Also TMHDA enables higher crosslinking mol % because it is a smaller compound

In an exemplary embodiment, both the anode and the cathode comprise an electrode anion exchange polymer comprising polyimidazolium or poly(arylimidazolium) polymer comprising an electrode functional group. An electrode functional group, anode polymer functional group and/or cathode polymer functional group may be selected from the group consisting of quaternary ammonium, tertiary diamines, phosphonium, benz(imidazolium), sulphonium, guanidinium, metal cations, and/or pyridinium. The anode and/or cathode polymer functional group may be quaternary ammonium. The membrane anion exchange polymer may include polynorbornene and the membrane functional group may comprise quaternary ammonium, in an exemplary embodiment. The membrane anion exchange polymer may include polyxanthene and the membrane functional group may include quaternary ammonium, tertiary diamines, phosphonium, benz(imidazolium), sulphonium, guanidinium, metal cations, and/or pyridinium. The membrane anion exchange polymer may include polyxanthene and the membrane functional group may include quaternary ammonium.

The membrane anion exchange polymer may include polynorbornene and the membrane functional group may comprise quaternary ammonium, in an exemplary embodiment. The membrane anion exchange polymer may include polyxanthene and the membrane functional group may include quaternary ammonium, tertiary diamines, phosphonium, benz(imidazolium), sulphonium, guanidinium, metal cations and/or pyridinium. The membrane anion exchange polymer may include polynorbornene and the membrane functional group may comprise quaternary ammonium, in an exemplary embodiment. The membrane anion exchange polymer may include polyxanthene and the membrane functional group may include quaternary ammonium, tertiary diamines, phosphonium, benz(imidazolium), sulphonium, guanidinium, metal cations, and/or pyridinium. The membrane anion exchange polymer may include polyxanthene and the membrane functional group may include quaternary ammonium. The anode and/or cathode polymer functional group may be quaternary ammonium.

An exemplary anion exchange membrane comprises a microporous support layer. The anion exchange polymer may be imbibed into pores of the microporous support layer. Also, the anion exchange polymer may extend as a layer on an anode side of the anion exchange membrane and/or as a layer on the cathode side of the anion exchange membrane. An exemplary porous polymer is selected from the group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers. The anion exchange membrane may have a thickness of the no more than 100 μm, or no more than about 50 μm, no more than about 25 μm, or even no more than 15 or 10 μm and any range between and including the thickness values provide.

The support material may be porous prior to coupling with the anion exchange polymer and may be porous or microporous having a mean flow pore size, as determined by a coulter porometer test, determined by Porous Materials Inc (PMI) (Ithaca NY) advanced capillary flow porometer, any of models 1100 to 1500 may be used, or equivalent. A porous support material may have a mean flow pore size of 500 microns or less, and may be microporous having a mean flow pore size of 100 microns, 50 microns or less, 20 microns or less, 10 microns or less, 5 microns or less, or even about 2 or even 1 micron or less. The anion exchange membrane with a support material may be non-porous having a Gurley time, as determined by a Gurley Precision Instruments, (Troy NY) 4340 test, of more than 200 seconds.

The anode catalyst may comprise oxides catalyst and the anode may further comprise an ionomer such as polynorbornene, poly(phenylene), polyxanthene, and preferably polyimidazolium. The cathode catalyst may comprise oxides catalyst and the cathode further comprise an ionomer such as polynorbornene, poly(phenylene), and preferably polyimidazolium or poly(arylimidazolium). An exemplary oxides catalyst may be supported or non-supported oxides such as NiFe₂O₄, IrO₂, CosO₄, CoCuOₓ, MnO₂, BaSrCuFeOₓ, PbRuOₓ, RuOₓ, IrRuOₓ, NiCoFeOₓ, NbOₓ, LaSrCoOₓ. The ionomer may include functionalized polyimidazolium-based polymer.

A cathode catalyst may comprise precious metal catalyst and the cathode may further comprise an ionomer. The precious metal catalyst may be Pt/C, Pt-transition metal alloy supported on carbon, or Pt black and the ionomer may be a functionalized polyimidazolium-based or poly(arylimidazolium)-based polymer.

### BRIEF DESCRIPTION OF THE FIGURES

The accompanying drawings are included to provide a further understanding of the invention and are incorporated in and constitute a part of this specification, illustrate embodiments of the invention, and together with the description to explain the principles of the invention.

FIG. 1 shows the cross-sectional view of an exemplary Membrane Electrode Assembly (MEA) having an anode gas diffusion layer, an anode with an anode catalyst and an anode anion exchange polymer, an anion exchange membrane having anion exchange polymer and a support layer, a cathode with a cathode catalyst and a cathode anion exchange polymer, and a cathode gas diffusion layer.

FIG. 2 shows the chemical structure of a cross-linked random polynorbornene with quaternary ammonium functional groups. This typical structure shows the cross linked polynorbornene which is a block co-polymer.

FIG. 3 shows the chemical structure of polyphenylene, which are synthesized by comprising ether free functionalized polyphenylene compounds integrated with functionalized poly(fluorene).

FIG. 4 shows the chemical structure of another type of polyphenylene.

FIG. 5 shows the chemical structure of cross-linked block polynorbornene before functionalization.

FIG. 6 shows a graph of current density versus voltage for membrane electrode assemblies with the listed polymers as binder polymers in the anode and electrode of said membrane electrode assembly.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

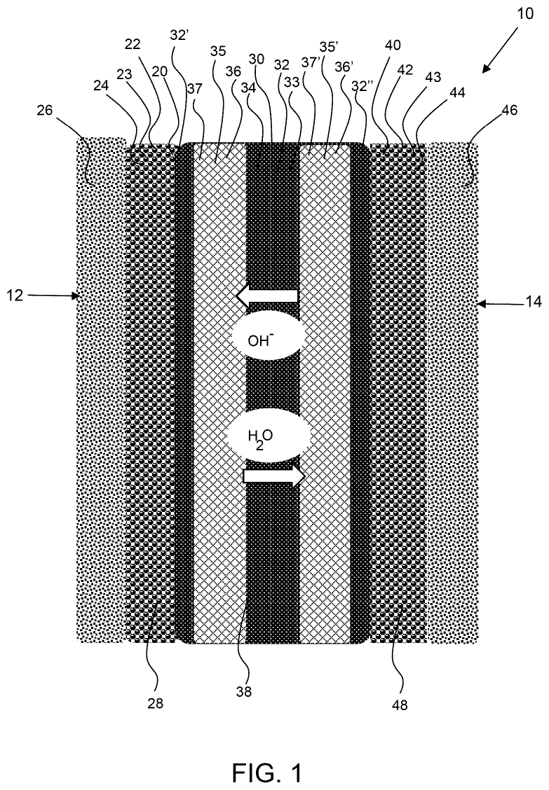

As shown in FIG. 1, an exemplary membrane electrode assembly 10 (MEA) has an anode gas diffusion layer 26, an anode 20, a cathode 40, and an anion exchange membrane 30 configured between and coupled with the anode and cathode and a cathode gas diffusion layer 46. The anode 20 has an anode catalyst 22 and an anode anion exchange polymer 23 with anode functional groups 24. The cathode 40 has a cathode catalyst 42, a cathode anion exchange polymer 43 with cathode functional groups 44. The anion exchange membrane 30 is configured between the anode 20 and cathode 40 and includes a membrane anion exchange polymer 33 having membrane functional groups 34. The anion exchange membrane has support layers 35 35′, which are multiple layers of a support material 37 that may have pores 36 that the anion exchange polymer 32 is imbibed or otherwise configured therein. The anion exchange membrane 30 has a first support layer 35 and a second support layer 35′ with a layer of anion exchange polymer 32 configured between the support layers. Also, a layer of anion exchange polymer 32′ is configured on the anode side 12 of the anion exchange membrane 30 and a layer of anion exchange polymer 32″ is configured on the cathode 14 side of the anion exchange membrane 30, membrane electrode assembly 10. The layer of anion exchange polymer between support layers may be different from the layer of anion exchange polymer on the anode side 12 and/or cathode side 14 of the anion exchange membrane. This configuration may provide high ion conductivity between the anode and the anion exchange membrane and the cathode and the anion exchange membrane while also providing mechanical support of the anion exchange membrane. Each of the support layers 35, 35′ of the respective support materials 37, 37′ having pores 36, 36′ that the anion exchange polymer 33 is imbibed into. An anode gas diffusion layer 26 is configured on the anode side 12 of the membrane electrode assembly 10 and a cathode gas diffusion layer 46 is configured on the cathode side 14 of the membrane electrode assembly 10. The functional groups may be chemically bonded to the anion exchange polymers of the anode, cathode and membrane and may be configured or coupled to side chains of the anion exchange polymer.

The membrane anion exchange polymer may be coupled with a support layer 35, such as by being imbibed into the pores 36 of the support layer 35 and/or by being coated onto or extending as a layer on an anode side and/or cathode side of the support layer. A support layer may be a microporous support layer having pores with a mean flow pore diameter of no more than about 10 microns, no more than about 5 microns, and in some cases no more than about 1 micron.

Additives, as described herein may be incorporated into the anode 20, cathode 40 and/or the anion exchange membrane 30 and may be mixed with or coupled to the anion exchange polymer of the anode, cathode and anion exchange membrane. An anode additive 28, cathode additive 48 and membrane additive 38 may be any of the additives as described herein, including radical scavengers, plasticizers, fillers, anion conducting material and/or crosslinking agent.

### Example 1

In one embodiment, a 30-micron membrane was prepared by dissolving the polynorbornene precursor polymer in toluene at a 15% weight ratio, with 15 g of polymer to 85 g of solvent. The mixture was stirred until homogenous and translucent. Afterwards TMHDA (N,N,N′,N′-Tetramethyl-1,6-diaminohexane) was used for 5 mol % crosslinking or as a cross linking agent to crosslink the anion exchange polymer. The concentration of the crosslinking agent may be about 4% mol % or more to about 10 mol % and may have a concentration of at least 5% mol % with respect to the anion exchange polymer

The polynorbornene precursor polymer solution was then applied to a microporous PTFE, expanded PTFE, material tensioned around a chemically resistant plastic frame.

### Example 2

An ink for the electrode was prepared according to the following Example:

A weight of 0.4 g cobalt oxides catalyst was dispersed in the 20 gram of a solvent mixture of acetone and methanol (1:1 weight ratio). This mixture as sonicated with a probe sonicator or ink homogenizer in an ice bath for 45 minutes. A solution of electrode anion exchange polymer was prepared by adding a weight of 1.6 gram of 5 wt % poly(arylimidazoliums) solution with acetone and methonal (1:1 weight ratio). This solution was added to the catalyst ink mixture. The precursor ink solution was sonicated with a probe sonicator or a ink homogenizer for another 5 minutes in an ice bath. The precursor ink solution was then transferred to an ink bottle and placed into bath sonicator for another 30 min sonication. For a hydrogen evolution electrode: a weight of 0.61 g Platinum supported on carbon catalyst was dispersed in a solvent mixture of DI water and ethanol (8.5 g and 34.1 g, respectively) to produce a catalyst ink solution. The catalyst ink solution was then sonicated with a probe sonicator or ink homogenizer in an ice bath for 45 minutes. The ink solution was formed by combining the electrode polymer solution with the catalyst ink solution. The electrode polymer solution was made by weighing 2.44 gram of 5 wt % poly(arylimidazoliums) solution in vial on a scale and dispersing the poly(arylimidazoliums) in a mixture of acetone and methanol (1:1 weight ratio). The electrode polymer solution was added to the catalyst ink solution and the ink mixture was sonicated with a probe sonicator or an ink homogenizer for another 5 minutes in ice bath. The ink solution was placed into an ice bath and sonicated for another 30 minutes. The binder concentration, or the concentration of the electron anion exchange polymer to the solids in the precursor ink solution was about ⅕ or about 20 wt % of the electrode anion exchange polymer.

### Example 3

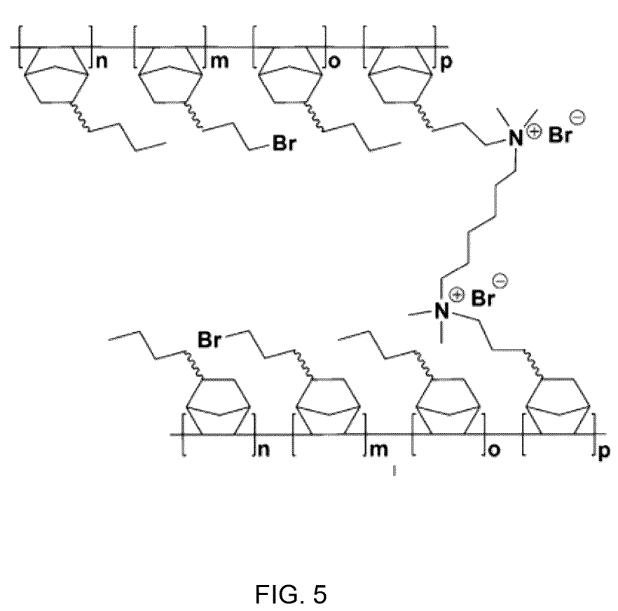

As shown in FIG. 5. The testing of membrane electrode assembly was conducted at 60 degree Celsius by recirculating the 1 molar potassium hydroxide into anode of the single-cell electrolyzer under a flow rate of 3-5 mL/min. The cathode of electrolyzer is under dry conditions.

In another embodiment, a membrane was prepared by dissolving the poly(phenylene) precursor polymer in toluene at a 10% weight ratio with 10 g of polymer to 90 g of solvent. The mixture was stirred until homogenous and translucent.

The poly(phenylene) precursor polymer was then applied to a support layer, a microporous PTFE material or membrane, with a doctor blade.

It will be apparent to those skilled in the art that the latter embodiment can be scaled up to a roll-to-roll, continuous process.

In the case of either embodiment, multiple coatings can be applied to increase the membrane thickness or to facilitate filling of the porous material.

In the case of either embodiment, the precursor polymer membrane can be soaked in trimethylamine solution in water or ethanol to convert the haloalkyl moieties within the precursor polymer to a trialkyl ammonium head-group enabling anion conduction within the membrane. The mobile halogen counter ion (e.g. bromide, chloride or iodide) can later be exchanged with hydroxide ions.

Optionally, the precursor polymer membrane can contain or be soaked in a diamine, such as tetramethyl hexyldiamine, to cross-link some or all of the haloalkyl moieties. The cross-linking is preferably carried out before the amination reaction in trimethylamine; however, cross-linking may also be carried out after amination.

In both embodiments, the membrane electrode assembly according to the invention has a free membrane margin which is not supported by a gas diffusion layer. The peripheral region, i.e. the distance from the outer edge of the membrane to the outer edge of the smaller gas diffusion layer on the cathode side, is small and in the assembled membrane-electrode assembly has a width of at least 0.5 cm around the circumference, preferably a width of at least 0.7 mm. For cost reasons, the width of the margin should be limited to a maximum of 6 mm around the circumference.

A further advantage of the electrolysis membrane electrode assembly of the invention is that, owing to the construction described, it has a stable structure which is easy to handle. The two catalyst layers or electrodes of the membrane electrode assembly are physically separated from one another by a greater distance in the peripheral region as a result of the construction according to the invention. The risk of a short-circuit is significantly reduced. In the subsequent processing steps (e.g. during installation of the sealing material), there is no risk of the poles being short-circuited by, for example, fibers from the gas diffusion layers.

Owing to the small width of the free membrane surface, the membrane consumption is limited. This leads to considerable cost savings compared to conventional membrane electrode assembly products.

The production process for the electrolysis membrane electrode assemblies of the invention consists of a combined process of porous transport layer and/or gas diffusion layer coating (“CCS process”), with the two substrates being coated with catalyst and ionomer on only one side. However, to achieve a higher catalyst loading, one side of the substrate can be coated several times.

To produce the membrane electrode assemblies, the precious metal free or precious metal catalysts are manufactured into inks using suitable solvents, with addition of functionalized polyimidazolium or poly(arylimidazolium) ionomer materials. The precious metal free catalyst is applied to a porous transport layer at the anode, and the precious metal catalyst is applied to gas diffusion layer for the cathode. The typical catalyst loading on the anode is in the range from 0.5 to 3.0 mg of catalyst/cm², and catalysts comprising NiFe₂O₄ are preferably used here. Standard hydrogen evolution reaction catalysts are used on the cathode side. The cathode loadings are in the range from 0.1 to 1.0 mg of Pt/cm². A drying process is then generally carried out to remove the solvents from the catalyst inks.

The carbon-based gas diffusion layers for the cathode can comprise porous, electrically conductive materials such as graphitized or carbonized carbon fiber papers, carbon fiber nonwovens, woven carbon fiber fabrics and/or the like. The carbon-based gas diffusion layer may comprise a microporous layer. The porous transport layer on the anode side can comprise a woven metal mesh, metal gauze, metal nonwoven, metal fibers, metal multifilament and/or another porous metallic structure. For example, sintered Ni felt can be used. The PTL may comprise a microporous layer.

The ion conducting membrane generally comprises hydroxide conducting polymer materials. Preference is given to using a polynorbornene, poly(phenylene) or polyxanthene having quaternary ammoniums groups. This material is marketed under the trade name For sealing or edging the membrane electrode assemblies of the invention, it is possible to use organic polymers which are inert under the operating conditions of water electrolysis and release no interfering substances. The polymers must be able to surround the gas diffusion layers in a gastight manner. Further important requirements which such polymers must meet are good adhesion behavior and good wetting properties in respect of the free surface of the ion conducting membrane. Suitable materials are firstly thermoplastic polymers such as polyethylene, polypropylene, PTFE, PVDF, polyamide, polyimide, polyurethane or polyester, and secondly thermoset polymers such as epoxy resins or cyanoacrylates. Further suitable polymers are elastomers such as silicone rubber, EPDM, fluoroelastomers, perfluoroelastomers, chloroprene elastomers and fluorosilicone elastomers.

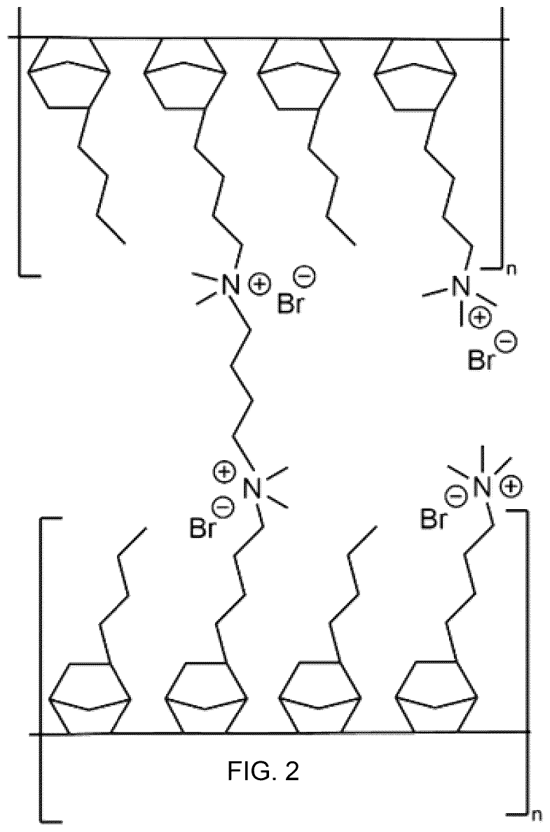

FIG. 2 shows the chemical structure of polynorbornene. This typical structure shows the cross linked polynorbornene which is an aminated block copolymer.

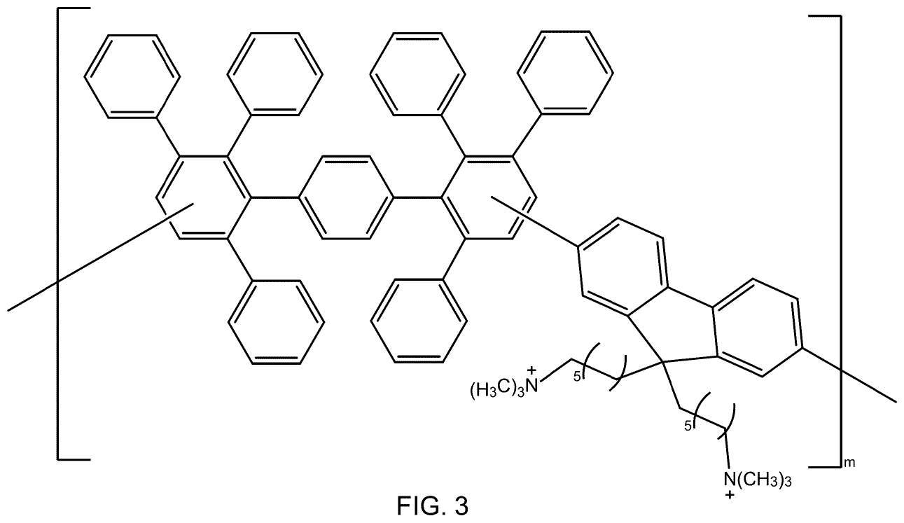

FIG. 3 shows the chemical structure of polyphenylene. which are synthesized by comprising ether free functionalized polyphenylene compounds integrated with functionalized poly(fluorene).

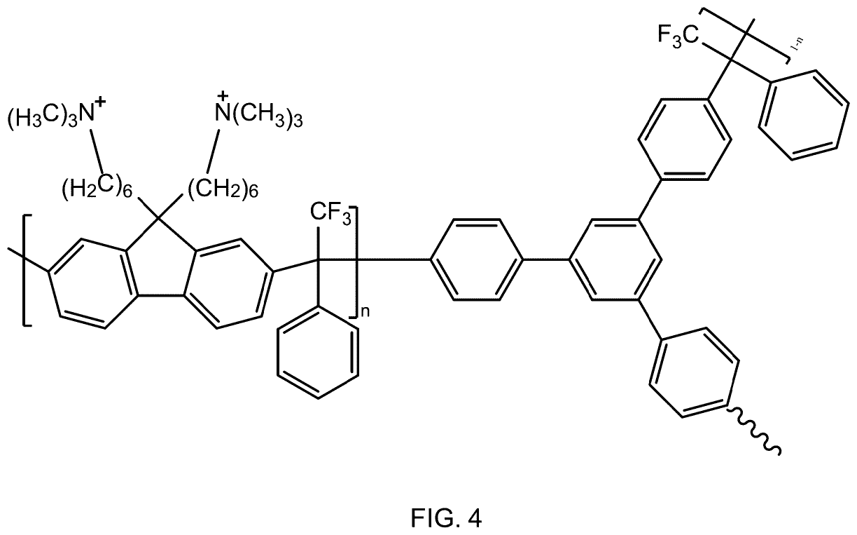

FIG. 4 shows the chemical structure of another type of polyphenylene.

FIG. 5 shows the chemical structure of cross-linked block polynorbornene before functionalization. FIG. 5 shows the chemical structure of polyxanthene. which are synthesized by comprising ether free functionalized polyxanthene compounds integrated with functionalized poly(fluorene).

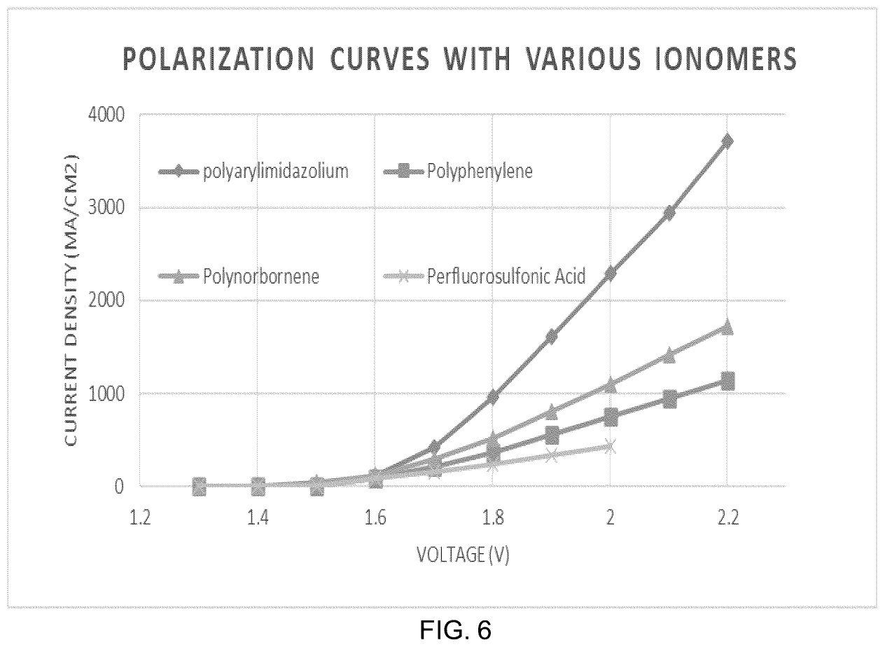

FIG. 6 shows a graph of current density versus voltage for membrane electrode assemblies with the listed polymers as binder polymers in the anode and electrode of said membrane electrode assembly.

FIG. 6 shows a graph of current density versus voltage for membrane electrode assemblies with the listed polymers as binder polymers in the anode and electrode of said membrane electrode assembly. A high ion exchange capacity (IEC) ionomer used as a binder in an electrode of a membrane electrode assembly can lead to high water uptake and swelling, which damages the three phase boundaries between the catalyst, ionomer and electrically conductive portion of the electrode, such as a catalyst carrier particle. On the contrary, an ionomer with too low of ion exchange capacity (IEC) may not be able to provide efficient ion conducting and limit the current density of the membrane electrode assembly. As shown in table 1, the IEC of polyxanthene is low.

TABLE 1

| Polymer | Polyarylimidazolium | Polyxanthene | Polynorbornene |
|---|---|---|---|
| IEC(mmol/g) | 2.1-2.6 | 1.7-1.9 | 3.0-3.7 |

Also, the interface between the electrode ion exchange polymer and the ion exchange polymer of the membrane can affect kinetic and ohmic overpotential. It has been found that using an electrode ionomer with medium ion exchange capacity provides the best interface with a polynorbornene polymer used as the anion exchange polymer in the membrane and as shown in the graph, provides the highest performance (highest current density). As shown, electrodes made with perfluorosulfonic acid had the lowest performance due to its cation exchange nature. In this study, all of the anion exchange membranes were made the same way with polynorbornene as the anion exchange polymer in the anion exchange membrane.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A membrane electrode assembly comprising:
a) an anion exchange membrane comprising a membrane anion exchange polymer that comprises polynorbornene having membrane functional groups;
b) an anode comprising an anode catalyst; and
c) a cathode comprising a cathode catalyst;
wherein both the anode and cathode each comprise an electrode anion exchange polymer comprising polyimidazolium polymer comprising an electrode functional group; and
wherein the membrane anion exchange polymer comprises polynorbornene and wherein the membrane functional group comprises quaternary ammonium.

2. The membrane electrode assembly of claim 1, wherein the membrane functional group is selected from the group consisting of quaternary ammonium, tertiary diamines, phosphonium, benz(imidazolium), sulphonium, guanidinium, metal cations, and pyridinium.

3. The membrane electrode assembly of claim 1, wherein the membrane functional group quaternary ammonium.

4. The membrane electrode assembly of claim 1, wherein the membrane anion exchange polymer comprises polynorbornene and wherein the membrane functional group is selected from the group consisting of quaternary ammonium, tertiary diamines, phosphonium, benz(imidazolium), sulphonium, guanidinium, metal cations, and pyridinium.

5. The membrane electrode assembly of claim 1, wherein the membrane anion exchange polymer comprises polynorbornene and the membrane functional group comprises quaternary ammonium.

6. The membrane electrode assembly of claim 1, wherein the electrode functional group is selected from the group consisting of quaternary ammonium, tertiary diamines, phosphonium, benz(imidazolium), sulphonium, guanidinium, metal cations, and pyridinium.

7. The membrane electrode assembly of claim 1, wherein the electrode functional group quaternary ammonium.

8. The membrane electrode assembly of claim 1, wherein the anode catalyst comprises oxides catalyst.

9. The membrane electrode assembly of claim 8, wherein the oxides catalyst is a supported or non-supported oxides wherein the oxide is selected from the group consisting of: NiFe₂O₄, IrO₂, CO₃O₄, CoCuOₓ, MnO₂, BaSrCuFeOₓ, PbRuOₓ, RuOₓ, IrRuOₓ, NiCoFeOₓ, NbOₓ, and LaSrCoOₓ.

10. The membrane electrode assembly of claim 9 wherein the anode comprises an anion exchange polymer comprising polyimidazolium comprising an electrode functional group.

11. The membrane electrode assembly of claim 1, wherein the cathode catalyst comprises precious metal catalyst.

12. The membrane electrode assembly of claim 11, wherein the precious metal catalyst is selected from the group consisting of: platinum on carbon, platinum-transition metal alloy supported on carbon, and platinum black.

13. The membrane electrode assembly of claim 1, wherein the membrane anion exchange polymer comprises an additive selected from a group consisting of radical scavengers, plasticizers, fillers, anion conducting material, crosslinking agent.

14. The membrane electrode assembly of claim 13, wherein the radical scavenger is an antioxidant selected from the group consisting of Cerium (Ce), Manganese (Mn), phenolic compounds, nitrogen-containing heterocyclic compounds, quinones, amine, phosphites, phosphonites, and thioesters.

15. The membrane electrode assembly of claim 13, wherein the additive comprises a plasticizer that is selected from the group consisting of nylon 6,6, Glycerol and ionic liquids.

16. The membrane electrode assembly of claim 13, wherein the additive comprises a filler that is a hygroscopic inorganic filler.

17. The membrane electrode assembly of claim 13, wherein the additive comprises a filler that a carbon-based material selected from the group consisting of oxides of aluminum, silicon, titanium, zirconium and zirconium phosphate, cesium phosphate, zeolites, clays and carbon black, multiwall carbon nanotubes, reduced graphene oxide.

18. The membrane electrode assembly of claim 13, where the additive comprises a crosslinking agent comprising tertiary diamine head groups comprising DABCO (1,4-diazabicyclo[2,2,2]octane) or TMHDA (N,N,N,N-tetramethylhexane diammonium), 1,4-diiodobutane.

19. The membrane electrode assembly of claim 1, wherein the anion exchange membrane comprises a support layer and wherein the anion exchange polymer is coupled with the support layer, and wherein the support layer has pores with an average mean flow pore size of no more than 500 microns.

20. The membrane electrode assembly of claim 19, wherein the anion exchange polymer is extends into the pores of the support layer.

21. The membrane electrode assembly of claim 19, wherein the support layer is a porous polymer that is selected from the group consisting of: polyolefins, polyamides, polycarbonates, cellulosics, polyacrylates, copolyether esters, polyamides, polyarylether ketones, polysulfones, polybenzimidazoles, fluoropolymers, and chlorinated polymers.

22. The membrane electrode assembly of claim 19, wherein a thickness of the anion exchange membrane is no more than 100 μm.

23. The membrane electrode assembly of claim 19, comprising a plurality said support layers and wherein the anion exchange polymer extends into the pores of each of said plurality said support layers.
